(19) United States
(12) Patent Application Publication
(10) Pub. No.: US 2015/0174448 A1
(43) Pub. Date: Jun. 25, 2015

(54) DISPLAY APPARATUS AND CONTROL METHOD THEREOF

(71) Applicant: SAMSUNG ELECTRONICS CO., LTD., Suwon-si (KR)

(72) Inventors: Sang-kyun IM, Seoul (KR); Cheon-seong LEE, Yongin-si (KR)

(73) Assignee: SAMSUNG ELECTRONICS CO., LTD., Suwon-si (KR)

(21) Appl. No.: 14/581,223

(22) Filed: Dec. 23, 2014

(30) Foreign Application Priority Data
Dec. 24, 2013 (KR) 10-2013-0162313

(51) Int. Cl. A63B 24/00; H04N 7/18; H04L 29/08; H04N 5/232

(52) U.S. Cl. CPC A63B 24/0062; H04N 5/232; H04N 7/183; H04L 67/12

(57) ABSTRACT

A display apparatus and a control method thereof are provided. The display apparatus includes: a display; an image capturer configured to acquire an image of an instrument board of a fitness device; and a controller configured to control the display to display exercise interworking information corresponding to an exercise condition determined based on the acquired image.

### CROSS-REFERENCE TO RELATED APPLICATION

This application claims priority from Korean Patent Application No. 10-2013-0162313, filed on Dec. 24, 2013 in the Korean Intellectual Properties Office, the disclosure of which is incorporated herein by reference in its entirety.

### BACKGROUND

1. Field

Apparatuses and methods consistent with exemplary embodiments relate to a display apparatus and a control method thereof, and more particularly to a display apparatus and a control method thereof, that employs instrument board information of a fitness device.

2. Description of Related Art

In general, fitness exercise equipment, such as a treadmill, a stationary bike, and the like, is installed indoors. The exercise equipment is convenient to accomplish an intended goal, i.e., to exercise, but is tedious because exercise is continuously repeated within an unchanged space.

Fitness exercise equipment usually includes an instrument board so that a user can check an exercise speed, an exercise time, an exercise mode, etc. Although such pieces of information on the instrument board are useful, the information has not been put to good use in the related art.

### SUMMARY

Aspects of one or more exemplary embodiments provide a display apparatus and a control method thereof, in which an instrument board of a fitness device being used by a user is recognized, and exercise interworking information is displayed corresponding to a user's current exercise condition, thereby offering a realistic image and useful health management information to a user.

According to an aspect of an exemplary embodiment, there is provided a display apparatus including: a display; an image capturer configured to acquire an image of an instrument board of a fitness device; and a controller configured to control the display to display exercise interworking information corresponding to an exercise condition information determined based on the image. Thus, an image and useful information about a user's exercise condition displayed on the instrument board of the fitness device being used to take exercise can be displayed on a large-sized TV or monitor screen.

The exercise condition may include at least one of a speed, a time, a slope, a burned calorie amount and an exercise mode. Thus, health management information useful to a user is provided using all pieces of information displayed on the instrument board of the fitness device.

The exercise interworking information may include information about at least one of a user's exercise amount, a user's exercise history and an interworking image. Thus, all pieces of information displayed on the instrument board of the fitness device are processed to provide information about a user's exercise history or exercise amount.

The interworking image may include one image selected from a plurality of images to correspond to a current exercise condition. Thus, a user can be offered with an image visibly showing his/her current exercise condition or an image proper to an exercise mode.

The controller may be further configured to control the display to apply a display effect selected from a plurality of display effects to the interworking image. Thus, if a user's exercise amount increases, an effect of a more active feeling such as a mount effect or a sloping-road effect can be applied to an image.

The display apparatus may further include a communicator to connect with a server, and the controller may be further configured to control the communicator to transmit the acquired image to the server, and receive the exercise condition information from the server. Thus, the image captured by photographing the instrument board is transmitted to the server storing respective model names of many kinds of fitness devices and information to be displayed on the instrument board, and it is thus possible to get information about what model corresponds to the corresponding instrument board, what pieces of exercise condition information are displayed, and where the information are displayed on the instrument board.

The image capturer may be further configured to receive a photographed image from the peripheral device.

The image capturer may include a communicator to be paired with the peripheral device. Thus, it is convenient to receive the image captured by photographing the instrument board of the fitness device from a paired smart phone, a paired remote controller mounted with a camera, etc.

The display apparatus may further include a storage configured to store instrument board information about a plurality of fitness devices, and the controller may use the instrument board information of the fitness device, stored in the storage, corresponding to the acquired image when the exercise condition information is determined based on the acquired image. Thus, it is possible to provide a user's exercise condition information based on the stored information without receiving the information about various kinds of fitness devices from the server.

According to an aspect of another exemplary embodiment, there is provided a method of controlling a display apparatus, the method including: acquiring an image of an instrument board of a fitness device; and displaying exercise interworking information corresponding to an exercise condition determined based on the acquired image.

The exercise condition may include at least one of a speed, a time, a slope, a burned calorie amount and an exercise mode.

The exercise interworking information may include information about at least one of a user's exercise amount, a user's exercise history and an interworking image.

The interworking image may include one image selected from a plurality of images to correspond to a current exercise condition.

The displaying the exercise interworking information may include displaying the interworking image to which a display effect has been applied, the display effect selected from among the plurality of display effects.

The method may further include connecting with a server, transmitting the acquired image to the server, and receiving the exercise condition information from the server.

The acquiring the image may include receiving a photographed image from the peripheral device.

The acquiring the image may include pairing with the peripheral device.

The method may further include storing instrument board information about a plurality of fitness devices, and using the stored instrument board information of the fitness device corresponding to the acquired image when the exercise condition information is determined based on the acquired image.

According to another aspect of an exemplary embodiment, there is provided a method of displaying fitness information, the method including: obtaining an image of a fitness device instrument board; determining, based on the obtained image, an instrument board layout; identifying exercise conditions of the fitness device based on the obtained image and the determined instrument board layout; determining interworking information based on the identified exercise conditions; and displaying corresponding interworking information on a display panel.

The determining of the interworking information may include determining a corresponding scenery based on the identified interworking information, and the displaying may further include displaying the determined corresponding scenery.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a block diagram of a display apparatus according to an exemplary embodiment;

FIG. 2 is a block diagram of a display apparatus according to another exemplary embodiment;

FIG. 3 is a flowchart showing a control method of a display apparatus according to an exemplary embodiment;

FIG. 4 is a flowchart showing a control method of a display apparatus according to another exemplary embodiment;

FIG. 5 is a flowchart showing a control method of a display apparatus according to still another exemplary embodiment;

FIG. 6 shows an exemplary operation of a display apparatus that recognizes an instrument board of a fitness device and provides exercise interworking information according to an exemplary embodiment;

FIG. 7 shows an exemplary operation of a display apparatus that recognizes an instrument board of a fitness device and provides exercise interworking information according to an exemplary embodiment;

FIG. 8 shows an interworking image being displayed as the exercise interworking information provided by the display apparatus according to an exemplary embodiment;

FIG. 9 shows an exercise amount being displayed as the exercise interworking information provided by the display apparatus according to an exemplary embodiment; and

FIG. 10 shows an exercise history being displayed as the exercise interworking information provided by the display apparatus according to an exemplary embodiment.

### DETAILED DESCRIPTION OF EXEMPLARY EMBODIMENTS

Hereinafter, exemplary embodiments will be described in detail with reference to the accompanying drawings. However, one or more exemplary embodiments may be embodied in many different forms, and should not be construed as being limited to exemplary embodiments set forth herein. Rather, these exemplary embodiments are provided so that this disclosure will be thorough and complete, and will fully convey the concept of the one or more exemplary embodiments to those of ordinary skill in the art. In the following description, unrelated parts may be omitted for clarity. Like reference numbers refer to like or similar elements throughout. Expressions such as “at least one of,” when preceding a list of elements, modify the entire list of elements and do not modify the individual elements of the list.

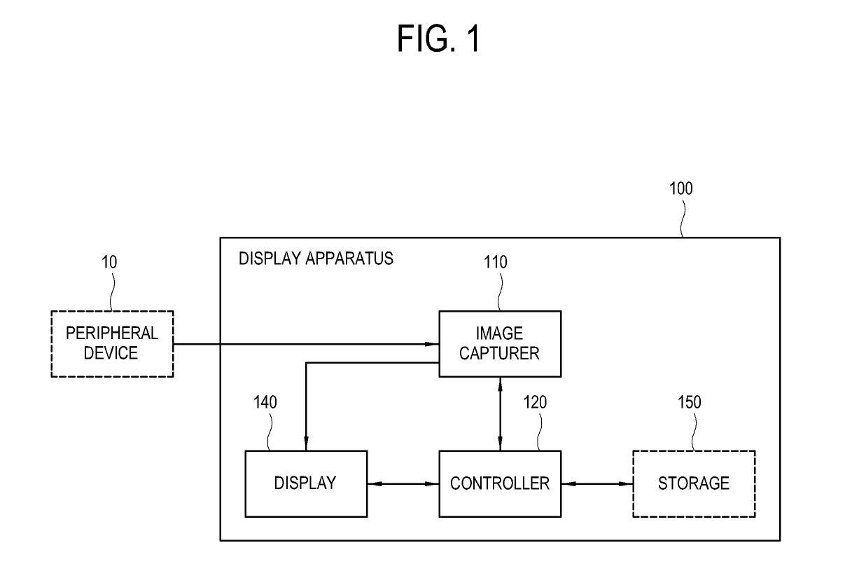

FIG. 1 is a block diagram of a display apparatus 100 according to an exemplary embodiment. As shown in FIG. 1, the display apparatus 100 includes an image capturer 110, a controller 120 and a display 140. The display apparatus 100 may further include a storage 150. Further, the display apparatus 100 may connect with a peripheral device 10.

For example, the display apparatus 100 may be a television (TV), a smart phone, a tablet computer, etc., and the peripheral device 10 may be a smart phone, a mobile device, a portable multimedia player (PMP), a tablet, a digital camera, a remote controller, or the like, including a camera. The display apparatus 100 may capture an image by photographing an instrument board of a fitness device being used by a user, and determine a user's exercise condition information or exercise condition based on the captured image. The display apparatus 100 may display exercise interworking information corresponding to the determined exercise condition information on the display 140. The exercise interworking information may be exercise information, health information, image information, etc., based on the determined exercise condition information. The exercise interworking information may include any information corresponding to the captured image or selected by a user, such as a speed, an incline, an exercise mode, a user, a burned calorie amount, a user history, an exercise amount, an interworking image, a scenic background, a time of day, a date, or the like. The display apparatus 100 according to an aspect of an exemplary embodiment may recognize the instrument board of the fitness device used by a user, and display the exercise interworking information based on a user's current exercise condition, thereby providing a health management service.

The image capturer 110 may capture an image by photographing the instrument board of the fitness device used by a user. According to an aspect of an exemplary embodiment, the image capturer 110 may receive a captured image from the peripheral device 10. In addition, the image capturer 110 may include a communicator to be paired with the peripheral device 10. Thereby, the image capturer 110 may receive a photographed image from the peripheral device 10.

The display 140 may display an image output from the image capturer 110. The type of display is not limited, and the display 140 may be achieved by any type of display, including a plasma display panel (PDP), a liquid crystal display (LCD), an organic light emitting diode (OLED), a flexible display, a cathode ray tube display (CRT), etc.

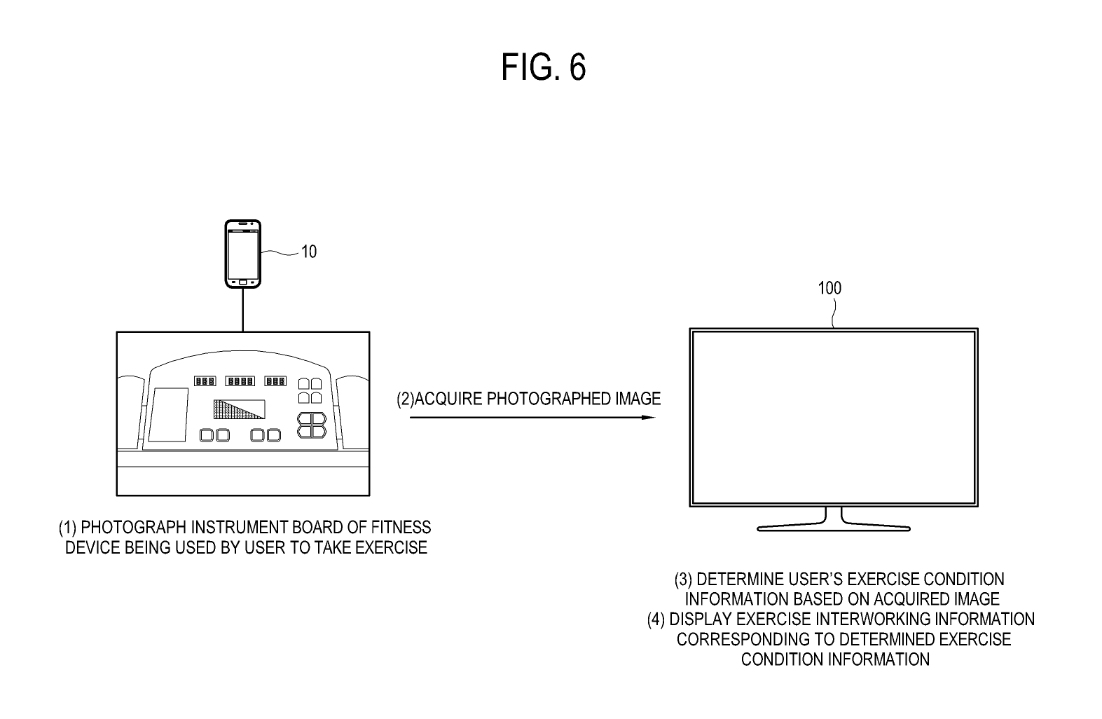

The controller 120 may control the display 140 to display the exercise interworking information corresponding to a user's exercise condition information. The user's exercise condition information may be determined based on the image captured by the image capturer 110. As shown in FIG. 6, a user may photograph the instrument board of the fitness device being used with the peripheral device 10, e.g., the smart phone, and a user's display apparatus 100, e.g., the TV, may acquire the image of the instrument board photographed by the peripheral device 10 and determine a user's exercise condition information based on the acquired image. The exercise condition information displayed on the instrument board of the fitness device includes at least one of a speed, a time, a slope, a burned calorie amount and an exercise mode.

The display apparatus 100 may further include the storage 150 for storing instrument board information about a plurality of fitness devices. For example, respective model names corresponding to various kinds of fitness devices and information displayed on each instrument board, e.g., instrument board layout information, are stored in a database on the storage 150, so that the display apparatus 100 can recognize a fitness device corresponding to the acquired instrument board image. The controller 120 may use the instrument board layout information of a recognized corresponding fitness device and the acquired image to determine the exercise condition information. Therefore, a user's display apparatus 100 may display the exercise interworking information corresponding to the determined exercise condition information. The exercise interworking information may include information about at least one of a user's exercise amount, an exercise history and an interworking image.

The interworking image may be displayed as one image content selected among a plurality of image contents in accordance with a user's current exercise conditions. The controller 120 may control, in accordance with a user's current exercise condition, a display effect, selected among a plurality of display effects (e.g., a plurality of prestored display effects), to be applied to the interworking image. For example, the plurality of image contents may be variously categorized and stored in the display apparatus 100. If a user's exercise amount increases, a mountain image, a sloping-road image, or the like may be selected as a content category for a more active feeling. An effect corresponding to the more active feeling may be applied to the selected and displayed image. Alternatively, if a user's exercise condition indicates a ‘mountain mode’ or a ‘sloping-road mode’, the mountain image or the sloping-road image may be displayed as the corresponding exercise interworking information.

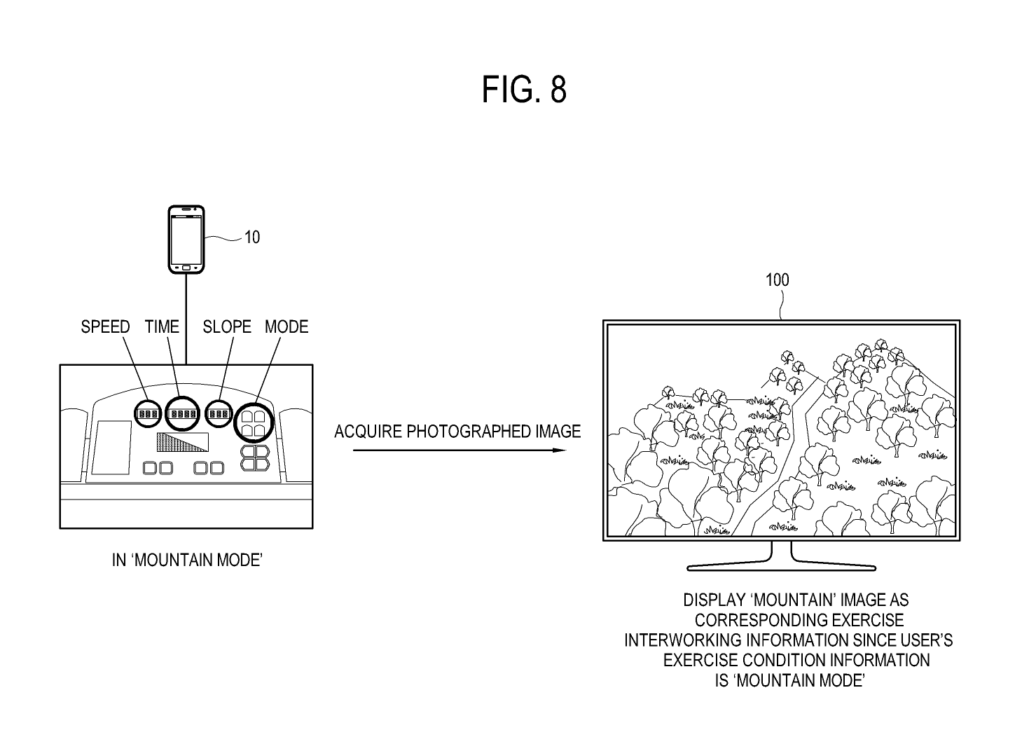

Specifically, as shown in FIG. 8, a user may photograph the instrument board of the fitness device being used through the peripheral device 10, e.g., the smart phone, and a user's display apparatus 100, e.g., the TV, may acquire the image of the instrument board photographed by the peripheral device 10. The image of the instrument board may include information about a user's exercise speed, exercise time, slope, exercise mode, etc. FIG. 8 shows an aspect of an exemplary embodiment wherein the ‘mountain mode’ is selected in the image of the instrument board. Thus, the user's display apparatus 100 determines a user's exercise condition as the ‘mountain mode’ based on the acquired instrument board image, and displays a mountain image as the corresponding exercise interworking information.

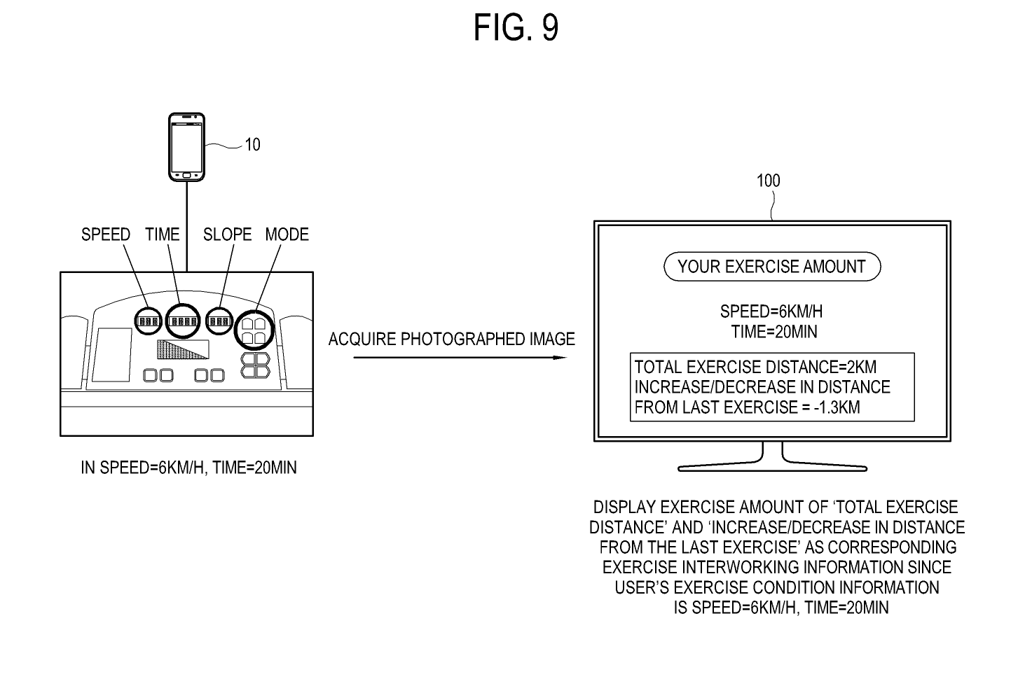

FIG. 9 shows another aspect of an exemplary embodiment, wherein a speed of 6 km/h and a time of 20 min are displayed in the image of the instrument board. Thus, the user's display apparatus 100 may determine a user's exercise condition information as ‘speed=6 km/h, time=20 min’ based on the acquired instrument board image. The display apparatus 100 may thereafter display an exercise amount of ‘total exercise distance=2 km’ and ‘increase/decrease in distance from the last exercise=−1.3 km’ as the corresponding exercise interworking information. The exercise amount displayed as the exercise interworking information is information obtained by processing the exercise condition information, e.g., speed and time. A user's previous exercise condition information may also be processed.

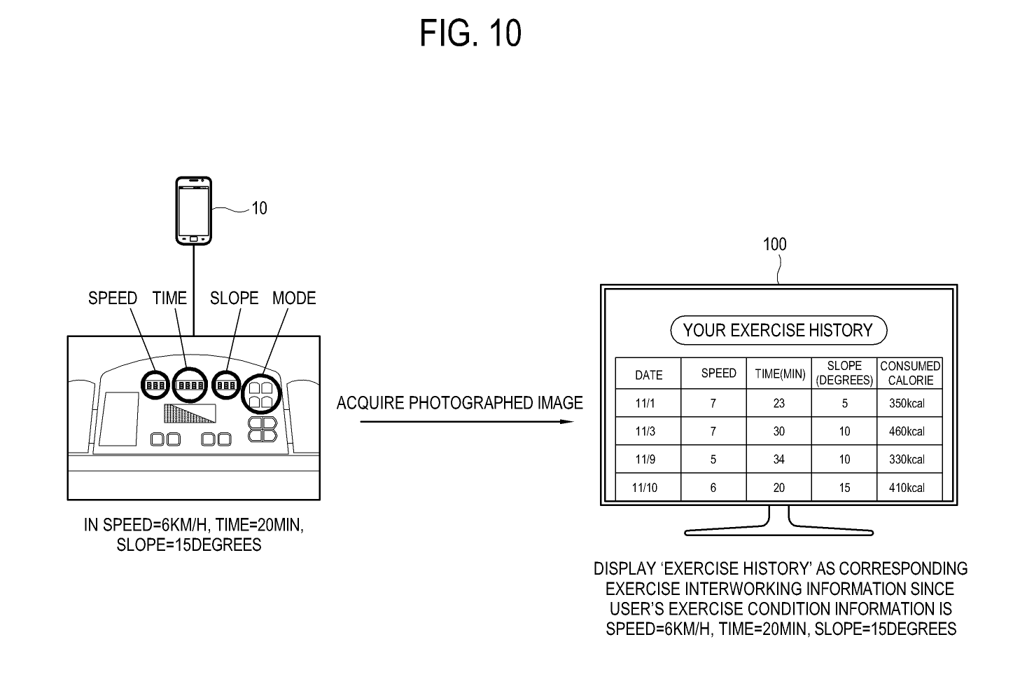

FIG. 10 shows an aspect of an exemplary embodiment, wherein a speed of 6 km/h, a time of 20 min and a slope of 15 degrees are displayed in the image of the instrument board. Thus, the user's display apparatus 100 may determine a user's exercise condition information as ‘speed=6 km/h, time=20 min, slope=15 degrees’ based on the acquired instrument board image, and display an exercise history as the corresponding exercise interworking information. The exercise history may include previous exercise condition information, and may, for example, include information about exercise dates, an exercise speed, an exercise time, a slope, a burned calorie amount, etc. The exercise history may be displayed on the instrument board with a corresponding date.

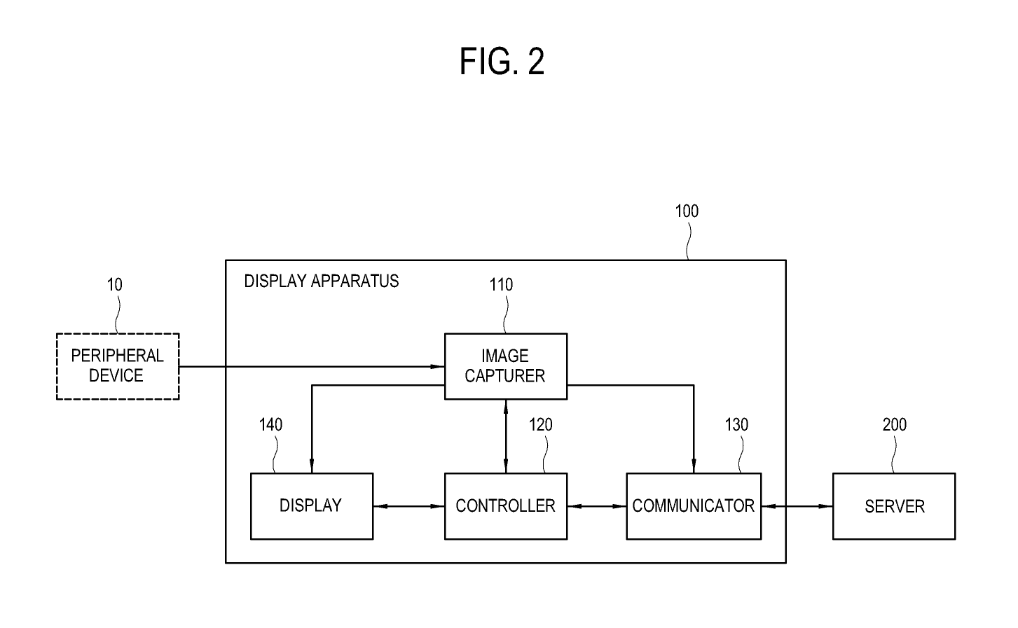

FIG. 2 is a block diagram of a display apparatus 100 according to another exemplary embodiment. As shown in FIG. 2, the display apparatus 100 includes an image capturer 110, a controller 120, a communicator 130 and a display 140. The display apparatus 100 may connect with a server 200 via the communicator 130. Further, the display apparatus 100 may connect with the peripheral device 10. For example, the display apparatus 100 may be a TV, a smart phone, a tablet computer, etc., and the server 200 may be a computer capable of processing massive data. The peripheral device 10 may be a smart phone, a remote controller mounted with a camera, etc.

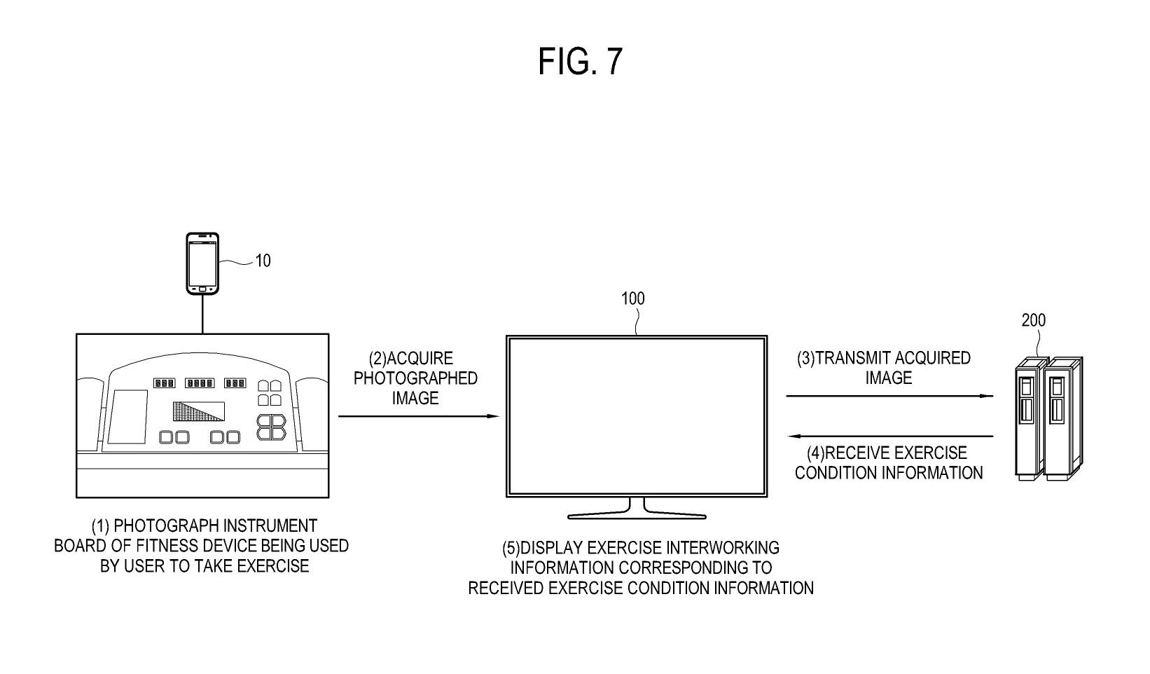

As shown in FIG. 2, the image capturer 110 may acquire an image of the instrument board of the fitness device being used by a user. The acquired image may be photographed by and received from the peripheral device 10, such as a smart phone or a remote controller mounted with a camera. The image capturer 110 may include a communicator to be paired with the peripheral device 10. The display 140 may display an image output from the image capturer 110, and the communicator 130 may connect with the server 200. In order to determine the exercise condition information based on the acquired image, as shown in FIG. 7, the controller 120 transmits the image captured by the image capturer 110 to the server 200, receives the exercise condition information from the server 200, and controls the display 140 to display the exercise interworking information corresponding to the received exercise condition information.

The server 200 may be provided with a database including model names corresponding to various kinds of fitness devices and information displayed on each instrument board. The display apparatus 100 may transmit the acquired image to the server 200 to determine which fitness device and model has an instrument board corresponding to the instrument board image acquired by the image capturer 110. The server 200 then determines what pieces of exercise condition information are displayed, and where the information are displayed on the instrument board. The display apparatus 100 may receive the exercise condition information based on the image from the server 200, and display the exercise interworking information corresponding to the received exercise condition information on the display 140.

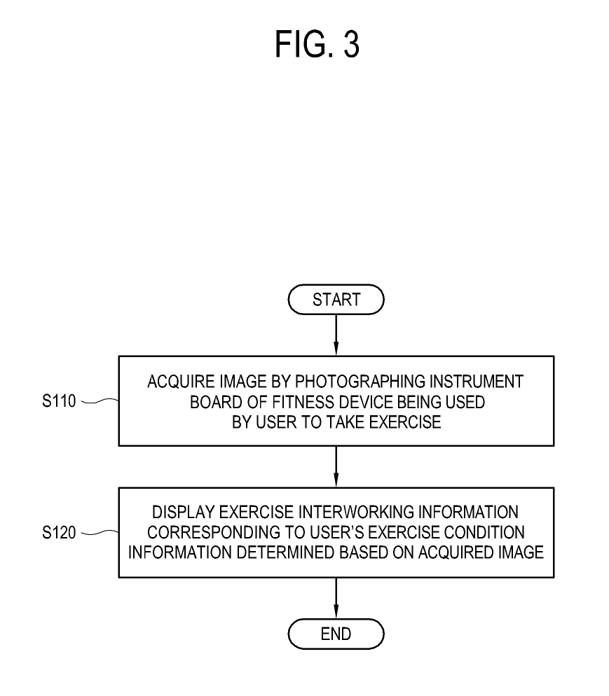

FIG. 3 is a flowchart showing a control method of a display apparatus according to an exemplary embodiment.

As shown in FIG. 3, at operation S110 an image may be acquired by photographing the instrument board of the fitness device being used by a user. The operation S110 of acquiring the image may include receiving a photographed image from the peripheral device. Next, at operation S120, the exercise interworking information corresponding to a user's exercise condition information, determined based on the acquired image, is displayed on the display. The exercise condition information may include at least one of a speed, a time, a slope, a burned calorie amount and an exercise mode displayed on the instrument board of the fitness device. The exercise interworking information may include information about at least one of a user's exercise amount, exercise history and an interworking image. The interworking image may be displayed as one image selected from among the plurality of image contents, corresponding to a user's current exercise condition. In this case, the operation S120 of displaying the exercise interworking information on the display, may include an operation of displaying an interworking image to which a display effect, selected corresponding to a user's current exercise condition among the plurality of display effects, is applied.

For example, as shown in FIG. 6, a user may employ the peripheral device, e.g., a smart phone, to photograph the instrument board of the fitness device being used, and a user's display apparatus, e.g., a TV, may acquire (e.g., receive or obtain) the image of the instrument board photographed by the peripheral device. A user's display apparatus 100 may determine a user's exercise condition information based on the acquired image, and display the exercise interworking information corresponding to the determined exercise condition information of a user on the display.

According to an exemplary embodiment shown in FIG. 8, if a user's exercise condition information based on the image of the instrument board is the ‘mountain mode’, a mountain image may be displayed as the corresponding exercise interworking information.

According to another exemplary embodiment shown in FIG. 9, if a user's exercise condition information based on the image of the instrument board is ‘speed=6 km/h, time=20 min’, an exercise amount of ‘total exercise distance=2 km’ and ‘increase/decrease in distance from the last exercise=−1.3 km’ may be displayed as the corresponding exercise interworking information. The exercise amount may be information obtained by processing the exercise condition information, e.g., speed and time, together with a user's previous exercise condition.

According to still another exemplary embodiment shown in FIG. 10, if a user's exercise condition information based on the image of the instrument board is ‘speed=6 km/h, time=20 min, and slope=15 degrees’, an exercise history may be displayed as the corresponding exercise interworking information. The exercise history includes one or more pieces of exercise condition information from the past, and may include, for example, information about exercise dates, an exercise speed, an exercise time, a slope, a burned calorie amount, etc., displayed on the instrument board corresponding to each date.

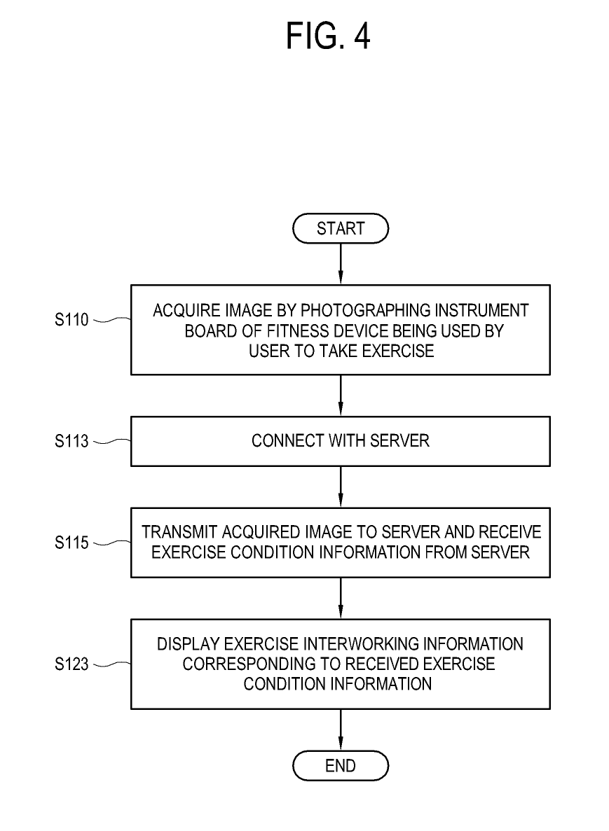

FIG. 4 is a flowchart showing a control method of a display apparatus according to another exemplary embodiment.

As shown in FIG. 4, at operation S110 an image captured by photographing the instrument board of the fitness device being used by a user is acquired. Next, at operation S113, connection with a server is performed. At operation S115, the acquired image is transmitted to the server, and the exercise condition information is received from the server. At operation S123, the exercise interworking information corresponding to the received exercise condition information is displayed on the display.

For example, as shown in FIG. 7, in order to determine the exercise condition information based on the acquired image, the acquired image is transmitted to the server 200, and the corresponding exercise condition information is received from the server 200. The display thereby displays the exercise interworking information corresponding to the received exercise condition information on the display.

The server 200 may be provided with a database including model names corresponding to various kinds of fitness devices and information displayed on each instrument board. The display apparatus 100 may transmit the acquired image to the server 200 in order to determine which fitness device and model has an instrument board corresponding to the acquired instrument board image. The server 200 then determines what pieces of exercise condition information are displayed, and where the pieces of exercise condition information are displayed on the instrument board.

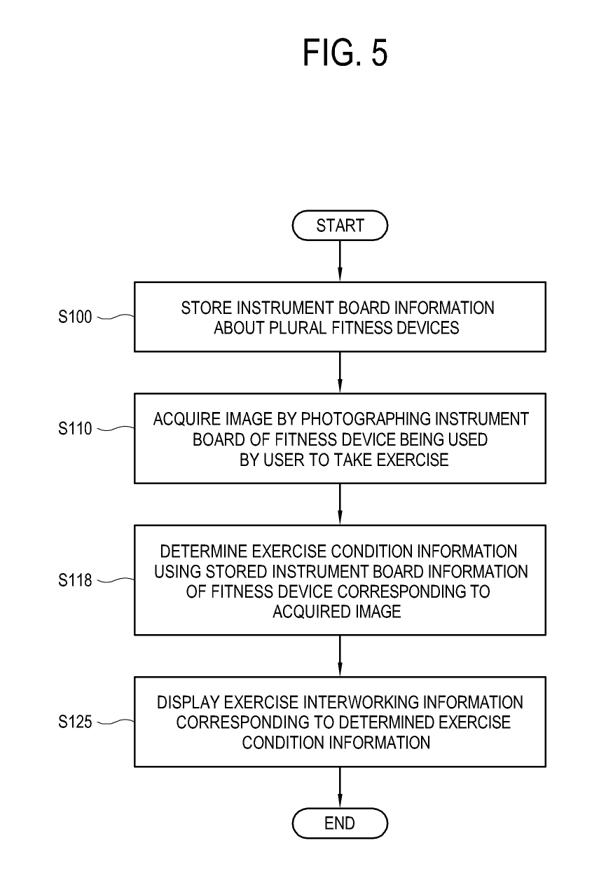

FIG. 5 is a flowchart showing a control method of a display apparatus according to still another exemplary embodiment.

As shown in FIG. 5, at operation S100, the instrument board information about a plurality of fitness devices is stored. Then, at operation S110, an image captured by photographing the instrument board of the fitness device being used by a user is acquired. At operation S118, exercise condition information is determined using the instrument board information of the fitness device in accordance with the acquired image. Lastly, at operation S125, the exercise interworking information corresponding to the determined exercise condition information is displayed on the display.

For example, a user's display or peripheral device may have previously stored information about the instrument boards for the plurality of fitness devices. For example, a user's TV or smart phone may have previously stored a database including respective model names corresponding to various kinds of fitness devices and information displayed on each instrument board. The stored information may be used to recognize which fitness device has an instrument board corresponding to the photographed instrument board image. A user's exercise condition information may thereby be determined, and the corresponding exercise interworking information may be displayed on the display.

Thus, the display apparatus 100, according to an aspect of an exemplary embodiment, may recognize the instrument board of the fitness device being used by a user, and display the exercise interworking information corresponding to a user's current exercise condition, thereby offering a realistic image and useful health management information to a user.

As described above, according to an aspect of an exemplary embodiment, an instrument board of a fitness device being used by a user may be recognized. Exercise interworking information may be displayed corresponding to the user's current exercise condition, thereby providing the user with a realistic image and useful health management information.

Exemplary embodiments may also be implemented in the form of a computer-readable recording medium including instructions executable by a computer, such as a program module executed by a computer. The computer-readable recording medium may be any available medium accessible by computers, examples of which may include a volatile recording medium, a nonvolatile recording medium, a removable recording medium, and an unremovable recording medium. Examples of the computer-readable medium may also include a computer storage medium and a communication medium. Examples of the computer storage medium may include a volatile storage medium, a nonvolatile storage medium, a removable storage medium, and an unremovable storage medium that are implemented by any method or technology for storing information such as computer-readable instructions, data structures, program modules, or other data. Examples of the communication medium may include any information transmission medium including computer-readable instructions, data structures, program modules, other data of modulated data signals, or other transmission mechanisms.

Although a few exemplary embodiments have been shown and described, it will be appreciated by those skilled in the art that changes may be made in these exemplary embodiments without departing from the principles and spirit of the invention, the scope of which is defined in the claims and their equivalents.

What is claimed is:

1. A display apparatus comprising:
a display;
an image capturer configured to acquire an image of an instrument board of a fitness device; and
a controller configured to control the display to display exercise interworking information corresponding to an exercise condition determined based on the acquired image.

2. The display apparatus according to claim 1, wherein the exercise condition comprises at least one of a speed, a time, a slope, a burned calorie amount and an exercise mode.

3. The display apparatus according to claim 1, wherein the exercise interworking information comprises information about at least one of a user's exercise amount, a user's exercise history and an interworking image.

4. The display apparatus according to claim 3, wherein the interworking image comprises an image selected from a plurality of images to correspond to a current exercise condition.

5. The display apparatus according to claim 3, wherein the controller is further configured to apply, to the interworking image, a display effect selected from a plurality of display effects.

6. The display apparatus according to claim 1, further comprising a communicator to connect with a server,
wherein the controller is further configured to control the communicator to transmit the acquired image to the server, and receive the exercise condition from the server.

7. The display apparatus according to claim 1, wherein the image capturer is further configured to receive a photographed image from the peripheral device.

8. The display apparatus according to claim 1, wherein the image capturer comprises a communicator configured to pair with the peripheral device.

9. The display apparatus according to claim 1, further comprising a storage configured to store a plurality of instrument board information corresponding to a plurality of fitness devices,
wherein the controller is further configured to use instrument board information, among the plurality of instrument board information, of the fitness device, stored in the storage, corresponding to the acquired image when the exercise condition is determined based on the acquired image.

10. A method of controlling a display apparatus, the method comprising:
acquiring an image of an instrument board of a fitness device; and
displaying exercise interworking information corresponding to an exercise condition determined based on the acquired image.

11. The method according to claim 10, wherein the exercise condition comprises at least one of a speed, a time, a slope, a burned calorie amount and an exercise mode.

12. The method according to claim 10, wherein the exercise interworking information comprises information about at least one of a user's exercise amount, a user's exercise history and an interworking image.

13. The method according to claim 12, wherein the interworking image comprises one image selected from a plurality of images to correspond to a current exercise condition.

14. The method according to claim 12, wherein the displaying the exercise interworking information comprises displaying the interworking image to which a display effect has been applied, the display effect selected from a plurality of display effects.

15. The method according to claim 10, further comprising:
connecting with a server;
transmitting the acquired image to the server; and
receiving the exercise condition from the server.

16. The method according to claim 10, wherein the acquiring the image comprises receiving a photographed image from the peripheral device.

17. The method according to claim 10, wherein the acquiring the image comprises pairing with the peripheral device.

18. The method according to claim 10, further comprising:
storing a plurality of instrument board information corresponding to a plurality of fitness devices; and
using instrument board information from among the stored plurality of instrument board information of the fitness device corresponding to the acquired image when the exercise condition is determined based on the acquired image.

19. A method of displaying fitness information, the method comprising:
obtaining an image of a fitness device instrument board;
determining, based on the obtained image, an instrument board layout;
identifying an exercise condition based on the obtained image and the determined instrument board layout;
determining interworking information based on the identified exercise condition; and
displaying the determined interworking information on a display panel.

20. The method according to claim 19, wherein:
the determining of the interworking information comprises determining a corresponding scenery based on the identified exercise condition; and
the displaying comprises displaying the determined corresponding scenery.

21. A method of displaying fitness information, the method comprising:
obtaining an exercise condition based on a captured image of a fitness device instrument board;
determining interworking information based on the obtained exercise condition; and
outputting the determined interworking information.

22. The method according to claim 21, wherein:
the outputting of the determined interworking information comprises determining a display effect from among a plurality of display effects and applying the determined display effect to the output determined interworking information.

23. The method according to claim 21, the method comprising:
identifying a user; and
storing the obtained exercise condition in an exercise condition database corresponding to the identified user.

24. A non-transitory computer readable medium storing a computer program for executing the method of claim 10.

25. A non-transitory computer readable medium storing a computer program for executing the method of claim 19.

26. A non-transitory computer readable medium storing a computer program for executing the method of claim 21.
